(19) United States
(12) Patent Application Publication
(10) Pub. No.: US 2017/0297871 A1
(43) Pub. Date: Oct. 19, 2017

(54) ELEVATOR LANDING DOOR ASSEMBLY AND ELEVATOR SYSTEM

(71) Applicant: Otis Elevator Company, Farmington, CT (US)

(72) Inventor: Jinzhong Zhang, Tianjin (CN)

(21) Appl. No.: 15/485,462

(22) Filed: Apr. 12, 2017

(30) Foreign Application Priority Data
Apr. 13, 2016 (CN) 201610226274.1

(51) Int. Cl. B66B 13/24; B66B 13/30; B66B 5/00

(52) U.S. Cl. CPC B66B 13/24; B66B 5/0031; B66B 13/30

(57) ABSTRACT

An elevator hall door assembly and an elevator system, wherein the elevator hall door assembly includes a hall door header provided with a guide rail, a hall door hanger plate capable of translating in the rail of the hall door header; hall door panels located below the hall door hanger plate; guide shoes at the bottom of the hall door panels; and a hall door sill provided under the hall door panels, the hall door sill having a guide groove extending in a translation direction of the hall door panels, and the guide shoes being accommodated in the guide groove; anti-off members are further provided at the bottom of the hall door panels.

### PRIORITY

This application claims priority to Chinese Patent Application No. 201610226274.1, filed 13 Apr. 2016, and all the benefits accruing therefrom under 35 U.S.C. §119, the contents of which in its entirety are herein incorporated by reference.

### TECHNICAL FIELD

The present invention relates to the technical field of elevators, and particularly, the present invention relates to an elevator hall door assembly and an elevator system provided with the elevator hall door assembly.

### BACKGROUND ART

Elevator hall doors, also known as elevator landing doors, are provided on each of the floors of a building. When the elevator does not stop, the elevator hall door usually remains closed, while when the elevator stops, the elevator hall door opens together with the elevator car door, so as to allow passengers to get on and off the elevator.

Recently, accidents caused by the elevator hall door being deformed or forced open due to severe impact have occurred many times. In order to avoid such accidents, various alterations are made on guide shoes of the elevator hall doors in the prior art, for example, the hall door sill is wrapped by the mounting plate for the guide shoes to enhance the impact resistance, etc. of the elevator hall doors.

### SUMMARY

The objective of the present invention is to improve the impact resistance of elevator hall doors.

The objective of the present invention is further to solve other defects present in the prior art.

In order to achieve at least one of the above objectives, according to one aspect of the present invention, a hall door assembly is provided, comprising:
hall door panels;
guide shoes at the bottom of the hall door panels; and
a hall door sill provided below the hall door panels, the hall door sill having a guide groove extending in a translation direction of the hall door panels, and the guide shoes being accommodated in the guide groove;
wherein anti-off members are further provided at the bottom of the hall door panels, the anti-off member extending partially into the guide groove, and the anti-off member comprising a body with a smaller width and a head with a larger width; when the hall door panels are closed, stoppers are provided at a position in the guide groove corresponding to the anti-off members, the stopper defining an opening the width of which is narrower than the head of the anti-off member, so as to prevent the anti-off member from escaping from the guide groove; and when the hall door panels translate, a vertical height position of the head of the anti-off member can be adjusted adaptively.

According to another aspect of the present invention, an elevator system is provided, the elevator system comprising the above elevator hall door assembly.

### BRIEF DESCRIPTION OF THE ACCOMPANYING DRAWINGS

With reference to the accompanying drawings, the content disclosed in the present invention will be more easily understood. It would be readily understood by a person skilled in the art that these drawings are for illustration only and are not intended to limit the scope of protection of the present invention. In addition, similar numerals in the drawings are used to represent similar components, wherein:

FIG. 1 shows a front view of an elevator hall door assembly;

FIGS. 2(a) and 2(b) respectively show an enlarged bottom view and a vertical sectional view of an elevator hall door assembly;

FIGS. 3(a) and 3(b) respectively show an enlarged bottom view and a vertical sectional view of an elevator hall door assembly according to an embodiment of the present invention;

FIG. 4 shows an anti-off member and a sill according to an embodiment of the present invention;

FIG. 5 shows an anti-off member and a sill according to another embodiment of the present invention; and

FIG. 6 shows another variant of an anti-off member and a sill of the present invention.

### DETAILED DESCRIPTION OF PREFERRED EMBODIMENTS

It can be readily appreciated that, according to the technical solution of the present invention, a person of ordinary skill in the art would put forward multiple interchangeable structural modes and implementations without changing the essential spirit of the present invention. Therefore, the following specific embodiments and drawings merely illustratively describe the technical solution of the present invention, but cannot be taken as the entirety of the present invention or as defining or limiting the technical solution of the present invention.

Orientation terms such as upper, lower, left, right, front, rear, front-face, rear-face, top and bottom mentioned or possibly mentioned in the present description are defined with regard to the structure shown in each figure, and are relative conceptions, and therefore, corresponding changes may be made according to different positions and different states of use. Hence, these or other orientation terms should not be interpreted as limiting terms.

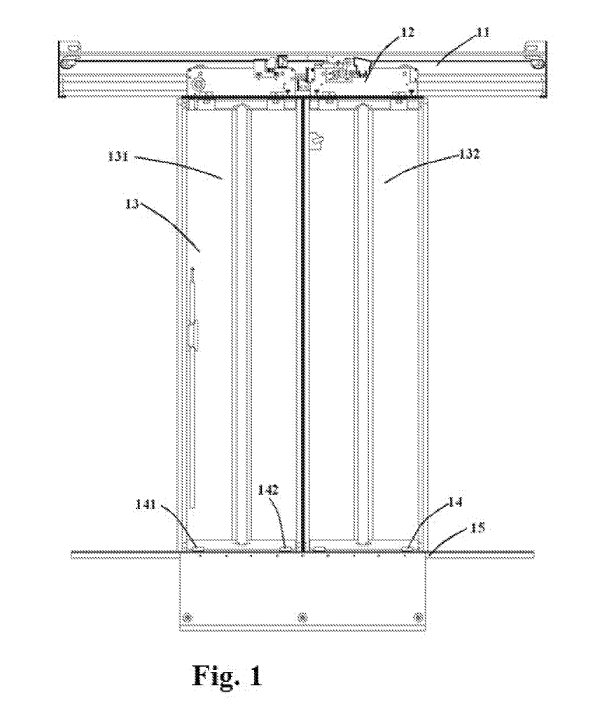

Firstly referring to FIG. 1, a front view of an elevator hall door assembly is shown. The elevator hall door assembly may be provided on each of the floors of a building. Generally, when an elevator car does not arrive at the floor where the hall door assembly is located, an elevator hall door remains closed, such as the state shown in FIG. 1, while when the elevator car arrives, the hall door may open together with an elevator car door, so as to allow passengers to enter and leave the elevator, for example, a hall door panel 131 moving to the left while a hall door panel 132 moving to the right until the door is fully opened in FIG. 1. Generally, an elevator hall door assembly may comprise: a hall door header 11 provided with a guide rail, a hall door hanger plate 12 capable of translating in the rail of the hall door header 11; hall door panels 13 located below the hall door hanger plate 12; multiple guide shoes 14 at the bottom of the hall door panels 13; and a hall door sill 15 laid on the floor. The hall door panels 13 may comprise two opposite hall door panels 131, 132, and two guide shoes 141, 142 may be provided at the bottom of each hall door panel 131. A guide groove is provided in the hall door sill 15 to accommodate each of the guide shoes 141, 142, and when the hall door panels 13 translate from a closed position shown in the figure to an open position or translate in the opposite direction, each of the guide shoes 141, 142 is guided by the guide groove of the hall door sill 15.

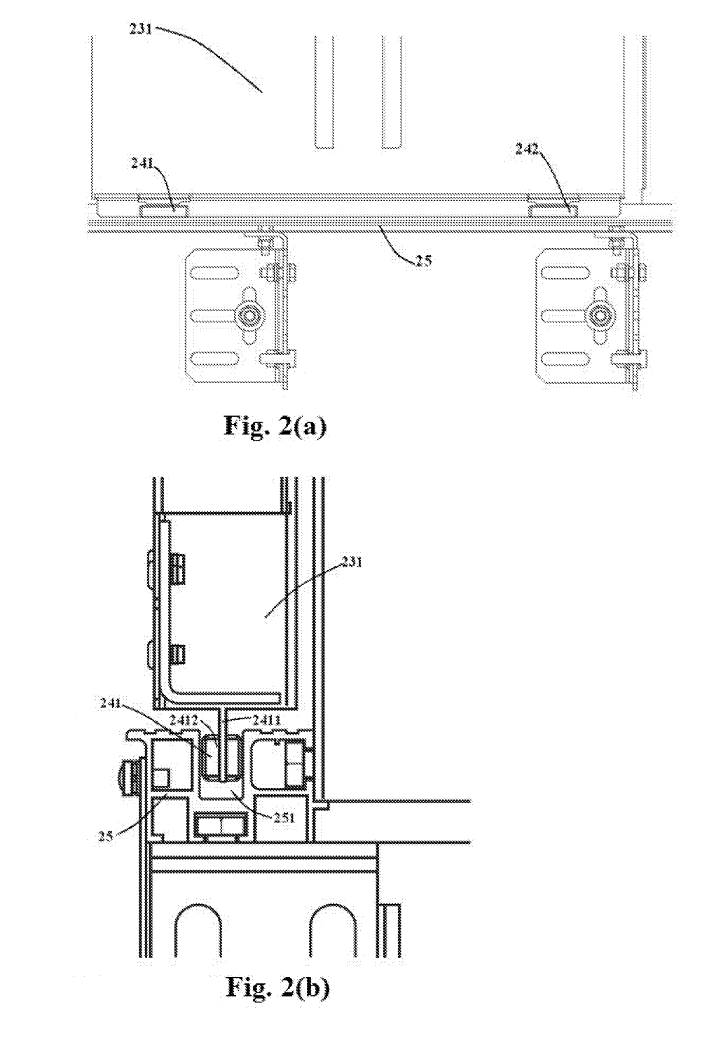

Referring to FIGS. 2(a) and 2(b), detail views of a guide shoe and a hall door sill are shown. Taking a hall door panel 231 as an example, the hall door panel comprises two guide shoes 241, 242 at the bottom thereof. Each of the guide shoes 241, 242 is accommodated by a guide groove 251 defined in a hall door sill 25. It is common that each guide shoe 241 is composed of a body 2411 made of a metal sheet and a wear layer 2412 wrapped on the body 2411. The body 2411 of the guide shoe is further fixed to the hall door panel 231, for example, by means of a bolt, etc., and when the wear on the wear layer 2412 reaches a certain level, each of the guide shoes may be removed and replaced.

It should be understood that each of the hall door panels 131, 132 is mainly hung and supported by the hall door hanger plate 12, and thus the hall door panels 131, 132 are not supported at the bottom; and the guide shoes at the bottom of the hall door panel and the guide groove in the hall door sill cooperate with each other to guide the translation movement of the hall door panel. When the hall door shown in FIGS. 1, 2(a) and 2(b) undergoes an impact, for example, when the hall door is struck in a direction from the outer side of the hall door and perpendicular to the plane of the paper as viewed in FIG. 1, since there is no limiting feature in the guide groove, in the case of a major impact, the hall door panels may be deformed and the guide shoes may escape from the guide groove so that the hall door panels are forced open, and people who strikes the hall door may even fall into an elevator shaft.

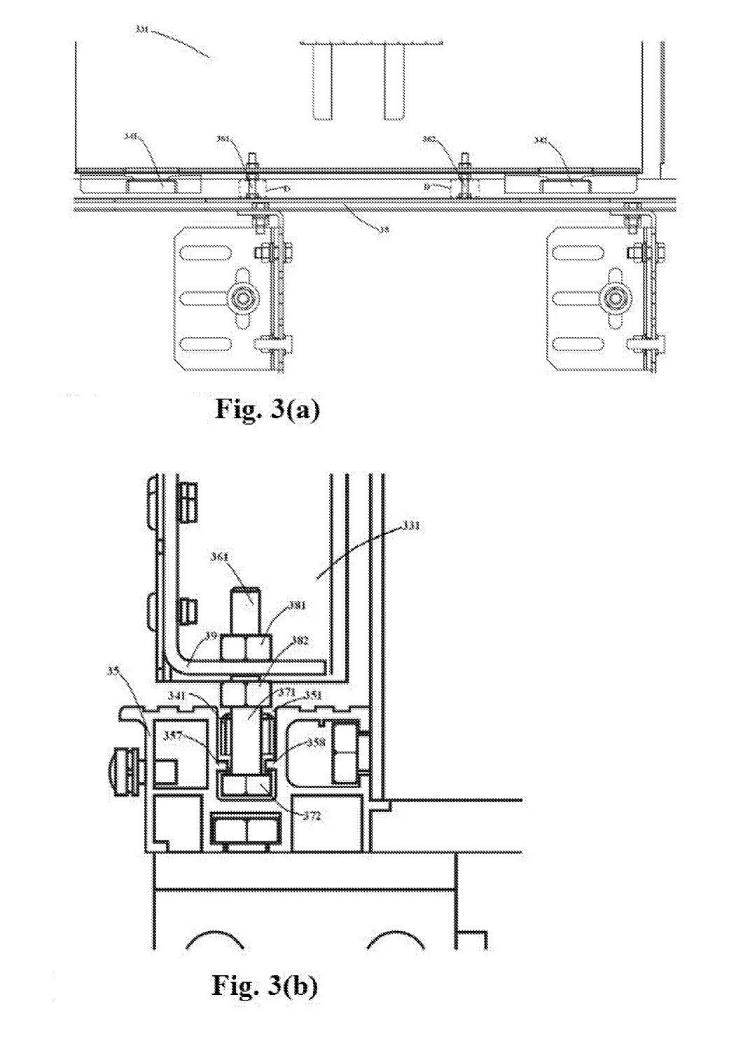

Now referring to FIGS. 3(a) and 3(b), the structure of an anti-off member and a hall door sill according to an embodiment of the present invention is shown. Also, a hall door panel 331 is taken as an example, and it should be understood that the other opposite hall door panel may have the same or similar structure. Two guide shoes 341, 342 are provided at the bottom of the hall door panel 331 and are accommodated by a guide groove 351 in a hall door sill 35. Furthermore, two anti-off members 361, 362 are further provided at the bottom of the hall door panel 331, and the anti-off members 361, 362 are provided at a position between the two guide shoes 341, 342 and close to the middle of the hall door panel. It should be understood that although the embodiment shown comprises two anti-off members, in alternate embodiments, one, three or more anti-off members may be provided at the bottom of the hall door panel. In the specific embodiment, the anti-off members 361, 362 take the form of bolts, such as T-bolts, and the anti-off member has a screw portion 371 and a head 372. As shown in FIG. 3(b), the screw portion 371 has a smaller width while the head 372 has a larger width. The screw portion 371 passes through a screw hole on a sheet 39 at the bottom of the hall door panel, and is fixed connected to the hall door panel through two nuts 381, 382. The lower part of the anti-off member 361 is accommodated by the guide groove 351 of the hall door sill (in the figure, the part extending into the guide grove 351 comprises the head 372 and a portion of the screw portion 371). The hall door panel 331 in FIG. 3(a) is in a closed position, wherein stoppers 357, 358 are provided at a position in the guide groove of the hall door sill 35 corresponding to the anti-off members 361, 362 or at a region D, and the stoppers 357, 358 define an opening the width of which is narrower than the head 372 of the anti-off member 361, so as to prevent the anti-off member 361 from escaping from the guide groove 351.

In the embodiment shown in the figure, the guide groove 351 comprises a bottom wall and a pair of side walls parallel with each other and perpendicular to the bottom wall. The stoppers 357, 358 are protrusions which are integrally formed with the sill and laterally extend out from the side walls of the guide groove 351. The stoppers 357, 358 in the guide groove 351 merely extend along the region D corresponding to the position of the anti-off members when the hall door panels are closed, rather than along the length of the whole guide groove 351, which facilitates the mounting of the hall door panels into the guide groove of the hall door sill. In addition, it can be seen from FIG. 3(b) that the position where the stoppers 357 and 358 are provided will not interfere the passing through of the guide shoe 341, that is, during the opening and closing of the hall door panels, the guide shoe 341 may pass smoothly through the region D provided with the stoppers 357 and 358. In one embodiment, stoppers and guide shoes may be provided at different height levels so that they do not interfere with each other.

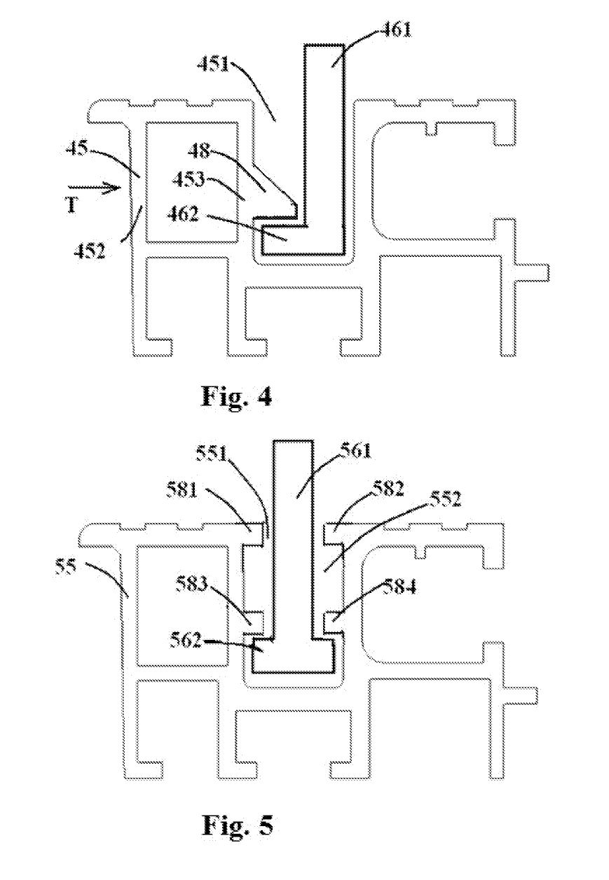

Although FIGS. 3(a) and 3(b) provide one example structure of the stopper and the anti-off member, the stopper and the anti-off member are not limited to the specific form. For example, referring to FIG. 4, an anti-off member has a body 461 with a smaller width and a head 462 with a larger width, and the entirety of the anti-off member has an L-shape in vertical cross-section. The anti-off member extends into a guide groove 451 defined by a hall door sill 45. A stopper 48 extends, at a position corresponding to the anti-off member when the hall door panels are at a closed position, integrally out from a side wall 453 of the guide groove 451, and the stopper defining an opening the width of which is narrower than the head 462 of the anti-off member, so as to prevent the anti-off member from escaping from the guide groove 451. The stopper 48 in the examples given above is integrally formed with the hall door sill 45, for example, in the case of the hall door sill being made of an aluminum alloy material, the stopper may be formed on an interior side wall in the guide groove of the hall door sill by extrusion molding. It should be understood that, in alternative embodiments, the stopper may also be a part that is mounted to the hall door sill. In one embodiment, the stopper may also be a bolt, the bolt, for example, penetrating an outer wall 452 and the side wall 453 in the direction of an arrow T from the side of the hall door sill, wherein the end of a screw of the bolt extends into the guide groove 451 and is above the head 462 of the anti-off member, a position substantially close to the stopper 48 shown in the figure; and likewise, the bolt can also prevent the anti-off member from escaping from the guide groove.

Referring to FIG. 5, in one embodiment, one pair of stoppers 581, 582 may be formed at an upper part of a guide groove 551 defined by a hall door sill 55, and even at the top shown in the figure, and another pair of stoppers 583, 584 may be formed oppositely at a lower part of the guide groove 551. Guide shoes of hall door panels may pass through a region 552 between the upper stoppers 581, 582 and the lower stoppers 583, 584. The use of the design with upper guide members and lower guide members may further enhance the impact resistance of the hall door panels.

As a variant of the embodiment of FIG. 5, the existence of only upper stoppers 581, 582 may be envisaged. In this case, a head 562 of an anti-off member may be located at a higher horizontal position than that shown in the figure, which enables a larger gap between the head 562 of the anti-off member and a bottom wall of the guide groove 551 and between the head of the anti-off member and the stoppers, thereby reducing the possibility of friction between the head 562 of the anti-off member and the guide groove and between the head of the anti-off member and the stoppers, as well as noise produced thereby during the opening and closing of a hall door.

In addition, the hall door sill is possibly deformed after a long time of use due to frequent carrying of cargo and passengers. In order to prevent the anti-off member and the stopper of the hall door sill from interfering with each other when the hall door panels translate which otherwise causes the hall door panels to be stuck or causes noise due to friction, in one embodiment of the present invention, a vertical height position of the head with a larger width of the anti-off member can be adjusted adaptively. This may be achieved by any one connection mode where the anti-off member is connected to the hall door panels and only the anti-off member is allowed to move in a vertical direction with respect to the hall door panels, such as a spring-based connection mode, a clamping connection mode and a connection mode based on a cushioning gasket. In one embodiment, the body of the anti-off member may be provided in the form of a rod, and the rod-shaped body is clamped by an elastic element to allow a vertical height of the body to be adjusted adaptively.

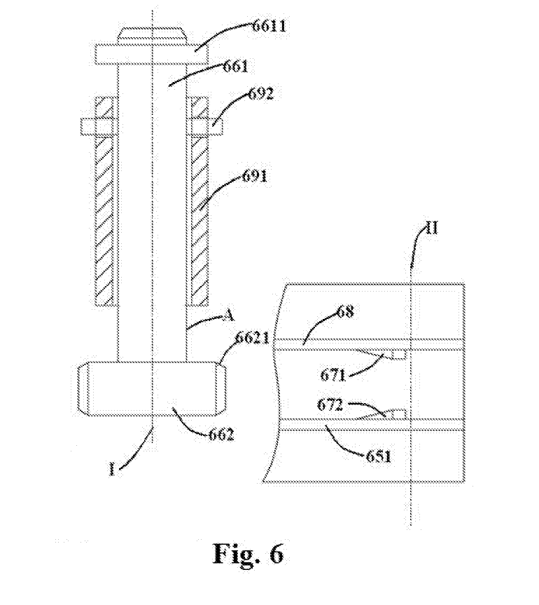

Referring to FIG. 6, an embodiment where adaptive adjustment is achieved. In one embodiment, a sleeve 691 is fixed connected to the bottom of the hall door panels, an elastic clamping ring 692 is supported by the sleeve 691, the elastic clamping ring 692 clamps a body 661 of an anti-off member so as to allow the adaptive adjustment of the anti-off member in a vertical direction, and a head 662 of the anti-off member may have a rounded edge 6621 to slide into a guide groove and between a stopper and a bottom wall.

In one embodiment, as shown in FIG. 6, when the anti-off member moves along the hall door panel to the right to a maximum open position (when an axis I of the anti-off member overlaps with an axis II in the figure, the hall door panel moves to the maximum open position), a height position of the head 662 of the anti-off member is corrected to an appropriate height position by a slope 672 provided on a bottom wall 651 of the guide groove and a slope 671 provided on a side wall protrusion 68, so as to avoid mutual interference or friction between the anti-off member and the stopper and between the anti-off member and the bottom wall of the guide groove when the hall door panel translates. In alternative embodiments, the slopes in the guide groove may be provided at any other position in the guide groove, as long as the head of the anti-off member is made to pass the slopes during the opening and closing of the hall door panels.

In one embodiment, as shown in FIG. 6, the body 661 of the anti-off member is provided with a flange 6611 that limits a height adjustment range thereof, and the anti-off member cannot be adjusted downwards any more when the flange 6611 is in contact with the sleeve 691. Likewise, the flange may also be provided at a position A on the body of the anti-off member.

In addition, in the above elevator hall door assembly, a sensor may be added to monitor any impact on the hall door panels. In one embodiment, the sensor may be a force sensor provided on the anti-off member or the stopper; when a forced sensed by the force sensor exceeds a threshold value, the elevator system may be forced to enter an emergency state, an alarm signal is sent, passengers in a car are evacuated on a nearest floor, and then the elevator car is sent to a floor where the impact occurs; thus, people are prevented from falling into an elevator shaft when the elevator hall door panels are damaged due to the impact.

In addition, the present invention is further to provide an elevator system, and the above elevator hall door assembly is provided on each of the floors of the elevator system. In some embodiment, the elevator hall door assembly further comprises a sensor monitoring whether the elevator hall door assembly undergoes an impact or not, and the elevator system further comprises an alarm device triggered in response to the sensor.

In one embodiment, the elevator hall door assembly further comprises a sensor monitoring whether the elevator hall door assembly undergoes an impact or not, the sensor being a force sensor provided on the anti-off member, and when the force sensor senses that hall door panels undergo an severe impact, the elevator system enters an emergency state and passengers in a car are evacuated on a nearest floor, and then the elevator system sends the elevator car to a floor where the hall door assembly undergoing the impact is located.

The specific embodiments described above are merely to describe the principles of the present invention clearer, wherein various components are shown or described clearly so as to make the principles of the present invention more comprehensible. A person skilled in the art would easily make various modifications or variations to the present invention without departing from the scope of the present invention. Hence, it should be understood that these modifications or variations should all fall into the protected scope of the present invention.

1. An elevator hall door assembly, comprising:
hall door panels;
guide shoes at the bottom of the hall door panels; and
a hall door sill provided below the hall door panels, the hall door sill having a guide groove extending in a translation direction of the hall door panels, and the guide shoes being accommodated in the guide groove;
characterized in that anti-off members are further provided at the bottom of the hall door panels, the anti-off member extending partially into the guide groove, and the anti-off member comprising a body with a smaller width and a head with a larger width; when the hall door panels are closed, stoppers are provided at a position in the guide groove corresponding to the anti-off members, the stopper defining an opening the width of which is narrower than the head of the anti-off member, so as to prevent the anti-off member from escaping from the guide groove; and when the hall door panels translate, a vertical height position of the head of the anti-off member can be adjusted adaptively.

2. The elevator hall door assembly according to claim 1, characterized in that the body of the anti-off member is formed in the shape of a rod.

3. The elevator hall door assembly according to claim 2, characterized in that the rod-shaped body of the anti-off member is clamped by an elastic clamping ring.

4. The elevator hall door assembly according to claim 3, characterized in that the elastic clamping ring is supported by a sleeve fixedly connected to the bottom of the hall door panels, and the body of the anti-off member passes through the sleeve.

5. The elevator hall door assembly according to claim 4, characterized in that the body of the anti-off member is provided with a flange that limits a height adjustment range thereof.

6. The elevator hall door assembly according to claim 3, characterized in that the guide groove is provided therein with a slope for adjusting the height of the head of the anti-off member.

7. The elevator hall door assembly according to claim 6, characterized in that the slope is provided in the guide groove and corresponding to the position of the anti-off member when the hall door panels are fully opened.

8. The elevator hall door assembly according to claim 1, characterized in that the guide groove comprises a bottom wall and a pair of side walls parallel with each other and perpendicular to the bottom wall.

9. The elevator hall door assembly according to claim 1, characterized in that the stopper and the hall door sill are integrally formed.

10. The elevator hall door assembly according to claim 1, characterized in that the stopper is formed as a protrusion horizontally extending out from the pair of side walls.

11. The elevator hall door assembly according to claim 10, characterized in that the hall door sill and the stopper are made of an aluminium alloy material, and the stopper is formed in the guide groove of the hall door sill by extrusion molding.

12. The elevator hall door assembly according to claim 11, characterized in that the stopper and the guide shoe are at different heights.

13. The elevator hall door assembly according to claim 1, characterized in that the stopper and the guide shoe do not interfere with each other during the opening and closing of the hall door panels.

14. The elevator hall door assembly according to claim 1, characterized in that the anti-off member is a bolt.

15. The elevator hall door assembly according to claim 1, characterized in that multiple spaced anti-off members are provided at the bottom of the hall door panels.

16. The elevator hall door assembly according to claim 1, characterized in that the elevator hall door assembly is further provided with a sensor monitoring whether the elevator hall door assembly undergoes an impact or not.

17. The elevator hall door assembly according to claim 16, characterized in that the sensor is a force sensor provided on the anti-off member or the stopper.

18. An elevator system, characterized in that the elevator system comprises an elevator hall door assembly according to claim 1.

19. The elevator system according to claim 18, characterized in that the elevator hall door assembly further comprises a sensor monitoring whether the elevator hall door assembly undergoes an impact or not, and the elevator system further comprises an alarm device triggered in response to the sensor.

20. The elevator system according to claim 18, characterized in that the elevator hall door assembly further comprises a sensor monitoring whether the elevator hall door assembly undergoes an impact or not, the sensor being a force sensor provided on the anti-off member, and when the force sensor senses that hall door panels undergo an severe impact, the elevator system enters an emergency state and passengers in a car are evacuated on a nearest floor, and then the elevator system sends the elevator car to a floor where the hall door assembly undergoing the impact is located.
